(19) United States
(12) Patent Application Publication
(10) Pub. No.: US 2026/0081930 A1
(43) Pub. Date: Mar. 19, 2026

(54) ATTACK DETECTION IN ROUND-TRIP TIMING USING ADJUSTABLE IMPULSE RESPONSE

(71) Applicant: Cypress Semiconductor Corporation, San Jose, CA (US)

(72) Inventors: Claudio REY, Chandler, AZ (US); Igor KOLYCH, Lviv (UA)

(73) Assignee: Cypress Semiconductor Corporation, San Jose, CA (US)

(21) Appl. No.: 18/884,895

(22) Filed: Sep. 13, 2024

(51) Int. Cl. H04L 9/40; H04L 25/02; H04L 43/0864

(52) U.S. Cl. CPC H04L 63/1416; H04L 25/0212; H04L 43/0864

(57) ABSTRACT

A wireless device includes a receiver and logic at least one of coupled to or integrated within the receiver. The logic receives, from a transmitter, a signal. The logic generates, based on an expected signal impulse response, a first expected signal. The generates, based on an attack pattern impulse response, an attack pattern. The logic determines, based on the signal, the first expected signal, the attack pattern, whether an attack is present in the signal.

### TECHNICAL FIELD

This disclosure relates to wireless networks and, more specifically, to attack detection in round-trip timing (RTT) using adjustable impulse response.

### BACKGROUND

Personal area networks (PANs), such as Bluetooth® (BT), Bluetooth® Low Energy (BLE), Zigbee®, infrared, and the like, provide a wireless connection for various personal, industrial, scientific, and medical applications. PANs generally use a packet-based protocol and have an architecture that includes central devices (CDs) and peripheral devices (PDs). A CD can communicate with multiple PDs over the PAN.

Some PANs, such as those based on BLE technology, have communication ranges similar to BT networks but have considerably smaller power consumption and cost. Further, BLE devices often remain in a sleep mode and transition to an active mode when data communication is about to happen. BLE protocol also supports mesh networking, in which data can flow over multiple paths, and which does not rely on a rigid hierarchical structure of devices, often allowing the same devices to serve as CDs or PDs, depending on particular network conditions and topology.

Additionally, some PANs are used in wireless devices (e.g., CDs) that are included in or associated with lock mechanisms of enclosures (such as a residence, a vehicle, a garage, a shed, or the like) and used to provide secure keyless access to persons in possession of a keyed PD, e.g., also referred to as keyless entry. The wireless CD device, which may also include or be coupled with a mobile device, may transmit a particular data pattern within a frame delimiter of a packet using BLE distance estimation technology. A keyed PD (which could be a mobile device such as a smartphone, for example) may estimate arrival time and return a particular data pattern within a frame delimiter of a packet using BLE distance estimation technology, e.g., in order to estimate round-trip timing (RTT) of packets. The wireless CD device may estimate an arrival time of the returned packet. The wireless devices may perform frame synch detection to verify that the particular data pattern matches an expected data pattern used to, in part, provide a level of security to the keyless entry based on distance ranging. This RTT-based ranging is susceptible to attack at least partially due to being able to be spoofed in certain ways of measuring, including a ranging technique.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1A is a block diagram of a system useable for attack detection in RTT using adjustable impulse response between a wireless device acting as a transmitter and a wireless device acting as a receiver, according to at least one embodiment.

FIG. 1B is a simplified block diagram illustrating the sending and receiving of packets during RTT estimation between a wireless device acting as a transmitter and a wireless device acting as a receiver, according to at least one embodiment.

FIGS. 2A and 2B is a simplified block diagram of the communication interface of a wireless device training to perform attack detection in RTT using adjustable impulse response, according to at least one embodiment.

FIG. 2C is a simplified block diagram of the communication interface of a wireless device performing attack detection in RTT using adjustable impulse response, according to at least one embodiment.

FIG. 3 is a simplified diagram of generating a signal using an impulse response, according to at least one embodiment.

FIG. 4 is a flow diagram of a method of training a wireless device to perform attack detection in RTT using adjustable impulse response, according to at least one embodiment.

FIG. 5 is a flow diagram of a method of performing attack detection in RTT using adjustable impulse response, according to at least one embodiment.

### DETAILED DESCRIPTION

The following description sets forth numerous specific details such as examples of specific systems, devices, components, methods, and so forth, in order to provide a good understanding of various embodiments of frame synchronization detection between wireless devices associated with a PAN. The disclosed principles may generally be applied to (Gaussian) Frequency Shift Keying ((G)FSK) modulation or (Binary) Phase Shift Keying ((B)PSK) modulation. Frame synchronization (or frame synch) detection may refer to detecting a frame delimiter, also referred to as a start frame delimiter (SFD), in a network packet identifying or signaling that data is to follow within a frame of the packet.

In certain PAN devices, frame synchronization detection can be used to aid in communication between wireless devices by identifying or signaling the data (i.e., payload data) that is to follow in a packet. Optionally, frame synchronization can also identify the sender of the packet. In certain PAN devices, frame synchronization or frame synchronization with data can be used as part of BLE distance estimation. BLE distance estimation is achieved through a phase-based distance ranging method, through packet exchanges in round trip timing (RTT) estimation, or a combination thereof to provide localization between wireless devices. In one example, data patterns (e.g., a sequence of digital “0s” and “1s”) are used in RTT estimation to estimate the time of arrival (ToA) of a packet, and data patterns are used in RTT estimation to estimate the time of departure (ToD) of a packet. In another example, BLE distance estimation can use the frequency estimated during the RTT estimation to synchronize the BLE distance estimation device to other BLE distance estimation devices through the correction of clocking errors and to estimate the frequency offset between devices. Additionally, BLE distance estimation can use data patterns to estimate frequency for use in security features, such as intrusion detection models. As such, there is a need for improved security features for BLE distance estimation devices.

As discussed previously, RTT-based ranging techniques used for security applications (e.g., location tracking using BLE RTT) can be vulnerable to spoofing attacks. Attackers employing various techniques like finite impulse response (FIR) filters, early commit late detect (ECLD)/early detect late commit (EDLC), and Amplitude Modulation (AM) which can impersonate legitimate devices. FIR filters alter specific frequencies within the RTT packet to disrupt frame synchronization, essentially creating a fake pattern that confuses the receiver. ECLD/EDLC exploits weaknesses in error correction codes or sends bursts of errors to make the receiver accept corrupted data or fail to detect errors altogether. AM manipulates the signal strength (amplitude) of the entire data transmission, overpowering or interfering with the legitimate signal (including the RTT packet) and making it difficult for the receiver to decode the data correctly.

Detection techniques, used as a security measures, can identify the utilization of these spoofing techniques. Detection techniques sample the signal properties at regular intervals (sampling rate) to analyze its characteristics for attack signatures. While protocols for transmitted signals are well-defined, variations in hardware implementation can impact detection effectiveness. For example, there may be ripples in the transmitted signal or frequency distortions. In frequency-modulated signals, the actual modulation might not reach the expected ±250 kHz range or may exceed it. These variations can create challenges for detection methods. Detectors relying on precise signal characteristics might work effectively for devices from some manufacturers but not others, potentially reducing the overall robustness of the detection technique across different hardware implementations.

In some instances, detection techniques calculate expected signal properties based on the characteristics of the receiver and transmitter involved in the communication, thereby predicting what a legitimate RTT packet should look like. However, this approach, known as analytical prediction, might not work under all conditions. The expected signal properties might vary depending on factors not considered in the analysis, such as environmental factors, hardware variations between different device manufacturers, and unexpected variations in the signal itself.

As a result, some detection techniques utilize neural networks instead of analytical prediction. These are trained on large datasets of signal samples, including those with variations and unexpected conditions, to be more adaptable in predicting what a legitimate RTT packet should look like for real-world scenarios. While neural networks improve detection accuracy, they can come at the cost of significantly increased power consumption and higher memory utilization.

Accordingly, to resolve the security vulnerabilities associated with BLE distance estimation employing RTT-based ranging techniques and to improve attack detection, the present disclosure involves a transmitter (e.g., a transmission device) and a receiver, and related systems and methods, that utilizes, in the receiver, impulse responses to calculate the expected signal and/or an attack pattern. The calculated expected signal and/or an attack pattern is then used in attack detection. For example, in some embodiments, a wireless device (e.g., a receiving device) includes receiving logic coupled to or integrated within a receiver of the wireless device.

This receiving logic, during training, is adapted to optimize precomputed impulse responses. The precomputed impulse responses may include, for example, an impulse response for an expected signal (e.g., expected signal impulse response) and/or an impulse response for an expected attack signal (e.g., expected attack signal impulse response). Thus, the transmitter may transmit various signals to the receiving logic (e.g., received signal) to optimize the expected signal impulse response or the expected attack signal impulse. The various signals may be a signal without any attacks, or a signal with a specific type of attack.

The receiving logic may compute an expected signal. Based on the type of received signal, indicated by the transmitter, the expected signal is an expected signal impulse response or an expected attack signal impulse. For example, the receiving logic inputs into a fitting method, such as a least square method, the received signal, and the expected signal. If the expected signal is an expected attack signal impulse, the receiving logic may compute an impulse response for an attack pattern associated with the expected attack signal impulse by subtracting the expected signal impulse response from the expected attack signal impulse.

The receiving logic, when deployed after training, receives a transmitted signal (e.g., received signal). The receiving logic generates an expected signal using the optimized expected signal impulse response. The receiving logic generates an attack pattern using the optimized attack pattern impulse response. The receiving logic obtains a signal difference between the received signal and the expected signal. The receiving logic correlates the signal difference and the attack pattern. The receiving logic compares the correlation to one or more thresholds to determine whether an attack is present in the received signal.

The present disclosure includes a number of advantages, including the ability to add additional aspects of security to distance estimations (e.g., the RTT-based ranging of BLE), which can be used to provide secure access to resources such as enclosures (e.g., a building or a vehicle), devices and/or device functionality, software, and any other resources to which any type of access or control is desired. In addition, the present disclosure involves small changes to existing infrastructure, thus avoiding the cost increases associated with other security techniques.

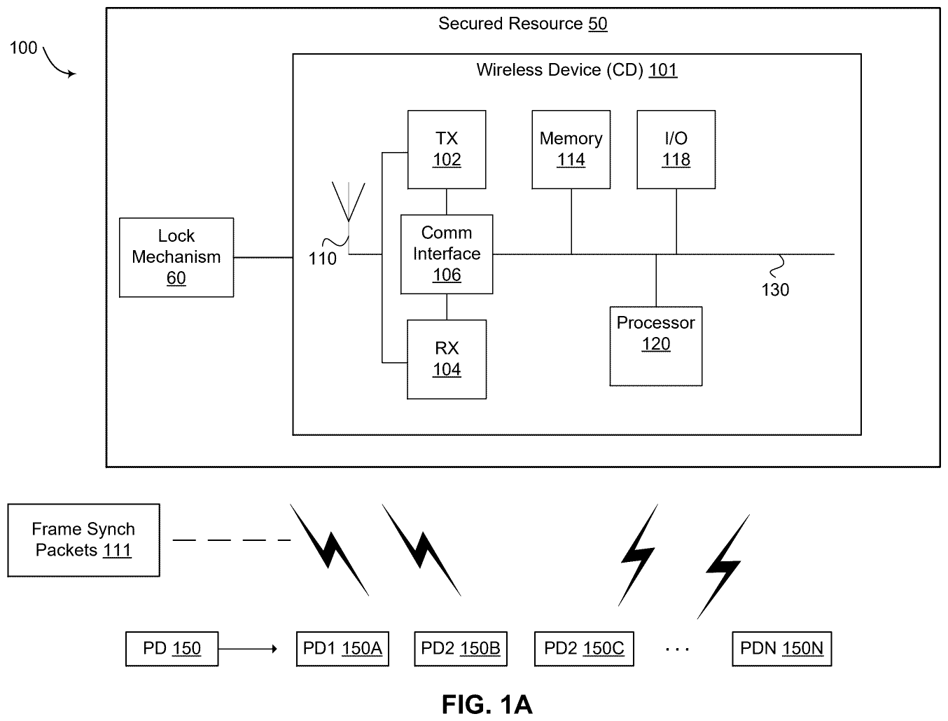

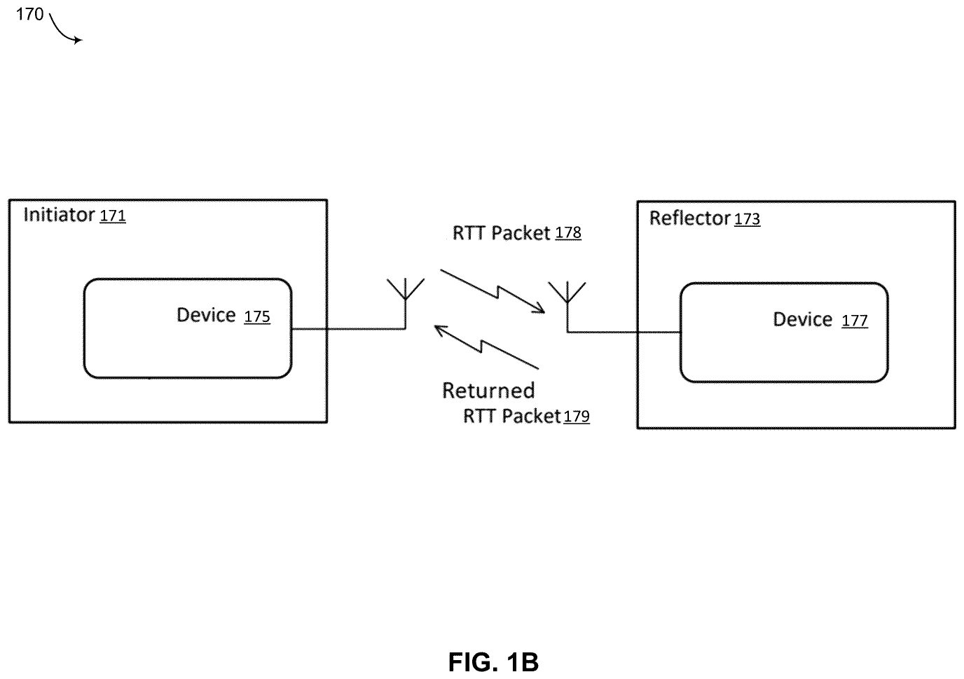

FIG. 1A is a block diagram of a system 100 useable for providing improved attack detection in round-trip timing (RTT) estimation between a wireless device 150 and a wireless device 101, according to an example embodiment. The wireless device 101 can act as a transmitter to set transmission time, and the wireless device 150 can act as a receiver, according to an example embodiment. In some embodiments, the wireless device 101 can act as a receiver to detect reception time, and the wireless device 150 can act as a transmitter. The difference between the reception time and the transmission time can be referred to as round-trip timing, which is described in further detail with respect to FIG. 1B. The system 100 can include a secured resource 50, e.g., that is secured using a lock mechanism 60, where the wireless device 150 is adapted to gain access to the secured resource 50 via the lock mechanism 60. The secured resource 50 can be, for example, an enclosure such as a vehicle, a building, a residence, a garage, a shed, a vault, or the like. The secured resource 50 can also be a computer system, industrial equipment, or other items requiring secured access via the lock mechanism 60, which can be a digital locking mechanism, for example. In some embodiments, the lock mechanism 60 is integrated together with the wireless device 101.

In various embodiments, the wireless device 150 is any one of multiple peripheral wireless devices PD1 150A . . . PDN 150N, as the wireless device 101 can be adapted to communicate with any or all of the peripheral wireless devices PD1 150A . . . PDN 150N. In differing embodiments, the wireless device 150 is a mobile device such as a mobile phone, a smart phone, a pager, an electronic transceiver, a tablet, or the like. In these embodiments, the wireless device 150 can be adapted to gain access to the secured resource 50 by transmitting data, including a frame delimiter and an enclosed frame. In some embodiments, the frame is encapsulated in a frame synch packet, and one or more frame synch packets 111 can be transmitted from the wireless device 150 to the wireless device 101. While the wireless device 101 is illustrated in detail, the wireless device 150 can also include the same or similar components as the wireless device 101, but are not repeated for simplicity. There can be transmission-reception symmetry between two wireless devices (however, the wireless device 150 is considered as a transmitter, and the wireless device 101 is considered as a receiver for simplification purposes).

In at least some embodiments, the wireless device 101 includes, but is not limited to, a transmitter 102 or TX (e.g., a PAN transmitter), a receiver 104 or RX (e.g., a PAN receiver), a communications interface 106, one or more antenna 110, a memory 114, one or more input/output (I/O) devices 118 (such as a display screen, a touch screen, a keypad, and the like), and a processor 120. These components can all be coupled to a communications bus 130.

In some embodiments, a separate antenna is employed for each of the transmitter 102 and receiver 104, and so the antenna 110 is illustrated for simplicity. In at least some embodiments, the memory 114 can include storage to store instructions executable by the processor 120 and/or data generated by the communication interface 106. In various embodiments, frontend components such as the transmitter 102, the receiver 104, the communication interface 106, and the one or more antenna 110 described herein within various devices may be adapted with or configured for PAN-based frequency bands, e.g., Bluetooth® (BT), BLE, Wi-Fi®, Zigbee®, Z-wave™, and the like.

In some embodiments, the communications interface 106 is integrated with the transmitter 102 and the receiver 104, e.g., as an RF front-end (RFFE) circuitry of the wireless device 101. The communication interface 106 may coordinate, as directed by the processor 120, to request/receive packets from the peripheral wireless device 150. The communications interface 106 can further process data symbols received by the receiver 104 in a way that the processor 120 can perform further processing, including verifying correlation between phase-based samples of data values obtained from a frame of a packet and an expected data pattern as part of a security protocol, as discussed herein.

FIG. 1B is a simplified block diagram 170 illustrating the sending and receiving of packets during RTT estimation between a wireless device 175 acting as an initiator 171 (e.g., a CD) and a wireless device 177 acting as a reflector 173 (e.g., a PD), according to at least one embodiment. In some embodiments, the initiator 171 can send (e.g., transmit) a packet 178 to the reflector 173. The reflector 173 can receive the packet 178 and can, for example, estimate arrival time of the packet 178. The reflector 173 can return a different packet 179 to the initiator 171 after a defined period from the arrival time. The initiator 171 can receive the returned packet 179 and can, for example, estimate arrival time of the returned packet 179. The initiator 171 can estimate time of flight (or round-trip timing) by subtracting times of sending and receiving events to estimate distance between the wireless device 175 and the wireless device 177, etc. Intrusion detection is performed on both devices.

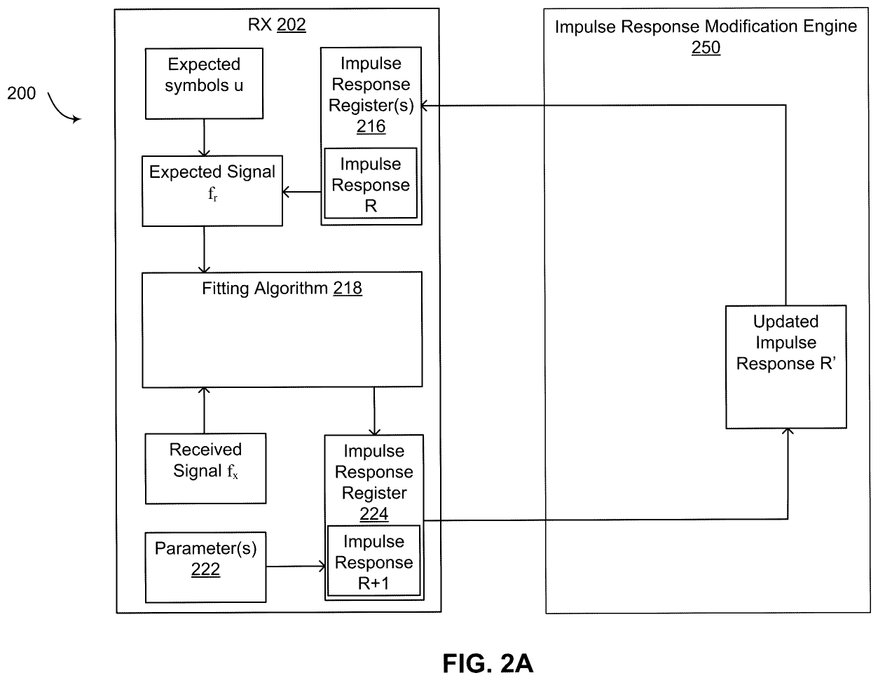

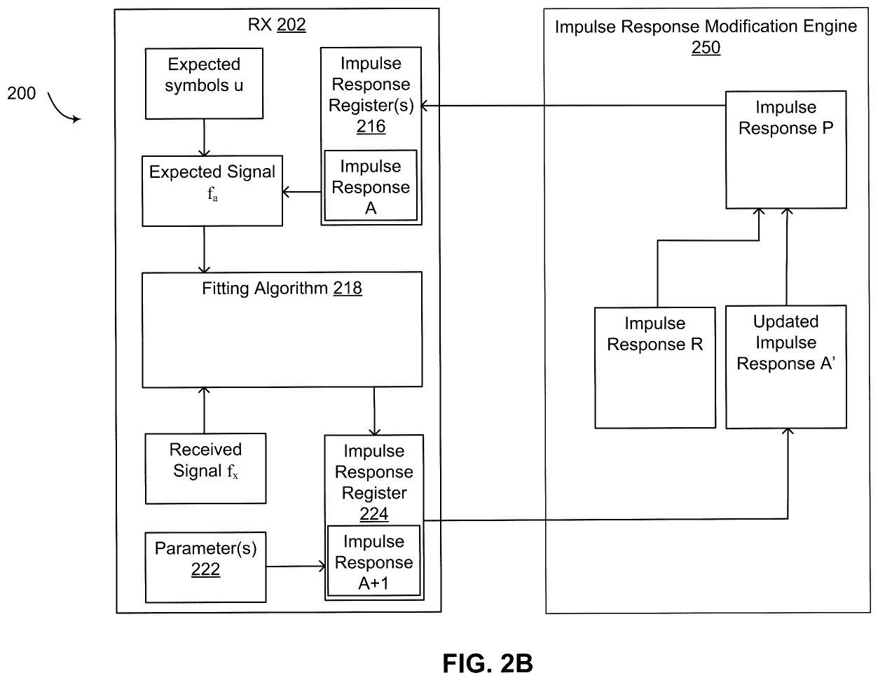

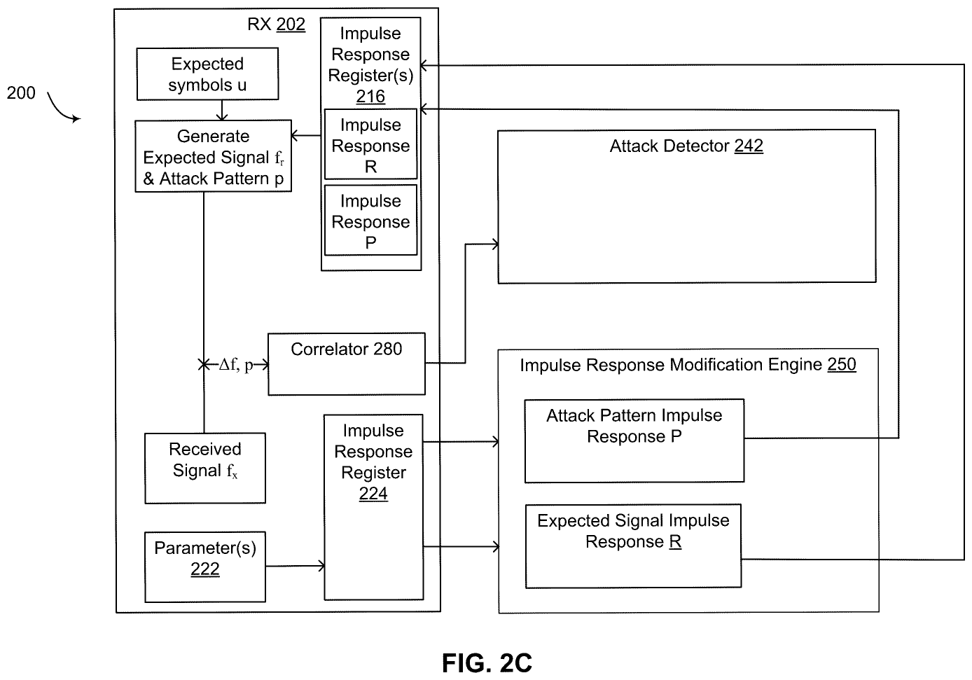

FIG. 2A is a simplified block diagram of the wireless device 101 and/or 150A of FIG. 1A that acts in receiver mode, according to at least one embodiment. Recall that the components of the wireless device 101 of FIG. 1A can also be included in the wireless devices 150A . . . 150N of FIG. 1A. Thus, the wireless device 101 can include a receiver (RX) 202 and a communication interface adapted with Bluetooth® low energy (BLE) (or narrow band communication technology) distance estimation capability.

In a location identified as safe from intrusion, the wireless device 101 may be trained for intrusion detection (e.g., in training mode). The location may be identified as safe from intrusion if the wireless device 101, for example, is located within the resource 50. In particular, the RX 202 receives, from a transmitter, a signal (e.g., received signal fₓ). In some embodiments, the received signal may be extracted, using the one or more RTT packets received from the transmitter. The signal transmitted by the transmitter may be, for example, a signal not affected by multipath or constructive interference (e.g., expected signal), a signal affected by multipath with destructive interference (e.g., multipath attack), or a signal emulating a specific attack. The RX 202 may provide an indication that the received signal fₓ is an intrusion (or attack).

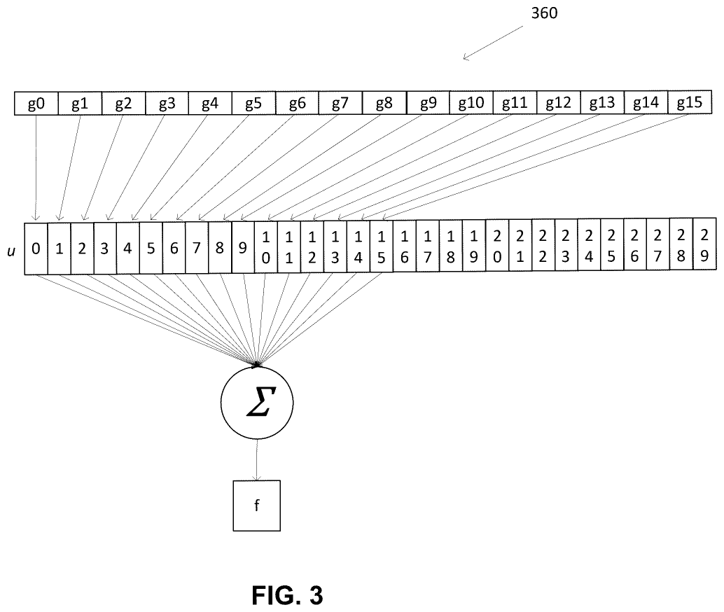

The RX 202 retrieves, from impulse response register(s) 216, a set of coefficients for an expected signal (e.g., impulse response R). Initially, impulse response register(s) 216 may store one or more precomputed impulse responses. The precomputed impulse response may be derived from an expected symbol. With quick reference to FIG. 3, a simplified diagram of generating a signal using an impulse response according to at least one embodiment, generates the expected signal fᵣ, by multiplying each coefficient of the impulse response R (e.g., impulse response 360) with a respective coefficient (e.g., g0-g15) by a sign of a corresponding symbol from the expected symbols u. As previously described, each symbol of the expected symbol u is represented as ±1. Then perform a convolution (e.g., Σ) of each coefficient from the impulse response R (e.g., g0-g15) with the correct sign as defined by a corresponding symbol of the expected symbols u (e.g., symbols 0-29 of the expected symbols u) to get the expected signal fᵣ (e.g., f). The expected signal fᵣ (e.g., f) is a vector having a similar size as the expected symbols u and the impulse response R (e.g., g0-g15) is applied as sliding window to the expected symbols u.

The RX 202 provides as input the received signal fₓ and the expected signal fᵣ into a fitting algorithm 218 to compute a new set of coefficients for the expected signal (e.g., impulse response R₊₁). The fitting algorithm 218 may be, for example, a least square method.

In some embodiments, the impulse response R₊₁, more specifically the set of coefficients associated with the impulse response R₊₁, may be stored in impulse response register 224 (and in some embodiments impulse response register(s) 216) and modified by one or more parameter(s) 222 in view of changeable filters of the RX 202. Modification may be performed using a multiplier, accumulator, or other components. The RX 202 may adapt or switch between different filter configurations based on certain criteria or conditions. The one or more parameter(s) 222 may include, for example, analog filter bandwidth, fractional timing, or packeting sampling location. Analog filter bandwidth attenuates high-frequency noise while preserving the signal and minimizing delay and phase distortion. Fractional timing allows for precise adjustments to signal sampling points at sub-sample levels, optimizing signal accuracy and alignment. Packet sampling location refers to the specific points in time at which a signal is sampled to form discrete data packets, crucial for accurate interpretation and analysis of digital data.

The communication interface of the wireless device 101 (e.g., communication interface 106) includes RF circuitry, which in turn, may include logic such as an impulse response modification engine 250. In some embodiments, the logic of the RF circuitry is at least one of coupled to or integrated within the receiver (e.g., RX 202). The impulse response modification engine 250 may receive, from the RX 202, impulse response R, impulse response R₊₁, and parameters. The impulse response modification engine 250 modifies impulse response R based on impulse response R₊₁ and parameters (e.g., it can be convolution between R₊₁ and representation of digital filters. More specifically, impulse response modification engine 250 applies a first weight to impulse response R (e.g., a weighted impulse response R) and a second weight to impulse response R₊₁ (e.g., a weighted impulse response R₊₁). In some embodiments, the second weight is complementary of the first weight, for example, second weight is substantially equivalent to 1 minus the first weight. The impulse response modification engine 250 adds the weighted impulse response R and the weighted impulse response R₊₁ to obtain an updated impulse response R′. The impulse response modification engine 250 replaces impulse response R with the updated impulse response R′.

Referring now to FIG. 2B, with the RX 202 still in training mode, the RX 202 may determine that the received signal fₓ contains an attack (e.g., multipath with deconstructive interference or an emulated attack). In some embodiments, the transmitter may notify the RX 202 that the received signal fₓ contains an attack pattern. Multipath refers to the phenomenon in which transmitted signals take multiple paths to reach the receiver due to reflection, diffraction, and scattering caused by obstacles like buildings, trees, and other environmental factors. These multiple paths can cause the signal to arrive at the receiver at slightly different times and with different phases, leading to constructive or destructive interference. Destructive interference, in some instances, are similar to some intrusion attempts such as FIR filter attack (or high pass filtering). Accordingly, depending on the embodiment, if multipath is present differentiating between constructive and destructive interference is essential. It involves identifying a distance for each path and utilizing the received signal from the antenna with the shortest distance.

The RX 202 retrieves, from impulse response register(s) 216, a set of coefficients for an expected attack signal (e.g., impulse response A). The RX 202 approximates, based on the expected symbols u and impulse response A, an expected attack signal fₐ. With quick reference to FIG. 3B, to generate the expected attack signal fₐ, for each coefficient of the impulse response A (e.g., impulse response 360), multiply a respective coefficient (e.g., g0-g15) by a sign of a corresponding symbol from the expected symbols u. . . . Then perform a summation (e.g., Σ) of each coefficient from the impulse response A (e.g., g0-g15) with the correct sign as defined by a corresponding symbol of the expected symbols u (e.g., symbols 0-29 of the expected symbols u) to get the expected attack signal fₐ (e.g., f).

The RX 202 provides as input the received signal fₓ and the expected attack signal fₐ into a fitting algorithm 218 to compute a new set of coefficients for the expected attack signal (e.g., impulse response A₊₁). The impulse response A₊₁, more specifically the set of coefficients associated with the impulse response A₊₁, may be temporarily stored in impulse response register 224. In some embodiments, one or more parameter(s) 222 may be used to modify the impulse response A₊₁ in view of changeable filters of the RX 202. The impulse response modification engine 250 modifies impulse response A based on impulse response A₊₁. More specifically, impulse response modification engine 250 applies a first weight to impulse response A (e.g., a weighted impulse response A) and a second weight to impulse response A₊₁ (e.g., a weighted impulse response R₊₁). The impulse response modification engine 250 adds the weighted impulse response A and the weighted impulse response A₊₁ to obtain an updated impulse response A′. The impulse response modification engine 250 replaces impulse response A with the updated impulse response A′.

In some embodiments, a set of coefficients for an attack pattern A can be computed using a mathematical equation, such as:

$$P = A - R ,$$

where P is the attack pattern coefficients which is a difference between the attack signal impulse response A and the impulse response of the expected signal R.

Referring now to FIG. 2C, in which the RX 202 has been trained for intrusion detection and switched to deployed mode. The RX 202, in deployed mode, generates, using known bit sequence, impulse response R and impulse response P stored in the impulse response register(s) 216, an expected signal fᵣ and an attack pattern p. The RX 202 provides as input, to correlator 280, a signal difference Δf and the attack pattern p. The signal difference Δf is computed by subtracting the received signal fₓ from the expected signal fᵣ. In some embodiments, a correlation (or frequency metric) can be computed by the correlator 280 using a mathematical equation, such as:

$$c = Δ f \cdot p ,$$

where c is provided to the attack detector 242 to be compared to one or more thresholds to determine whether the received signal is a specific attack.

In some embodiments, one or more parameter(s) 222 may be provided to the impulse response modification engine 250. The one or more parameters define filtering properties of the receiver (e.g., RX 202) to assist in stitching multiple impulses responses. The impulse response modification engine 250 may generate, based on one or more parameter(s) 222, a new impulse response for the expected signal and/or a new impulse response for the attack pattern. The impulse response modification engine 250 may override the one or more impulse responses used to generate the expected signal and the attack pattern with the new impulse response for the expected signal and the attack pattern.

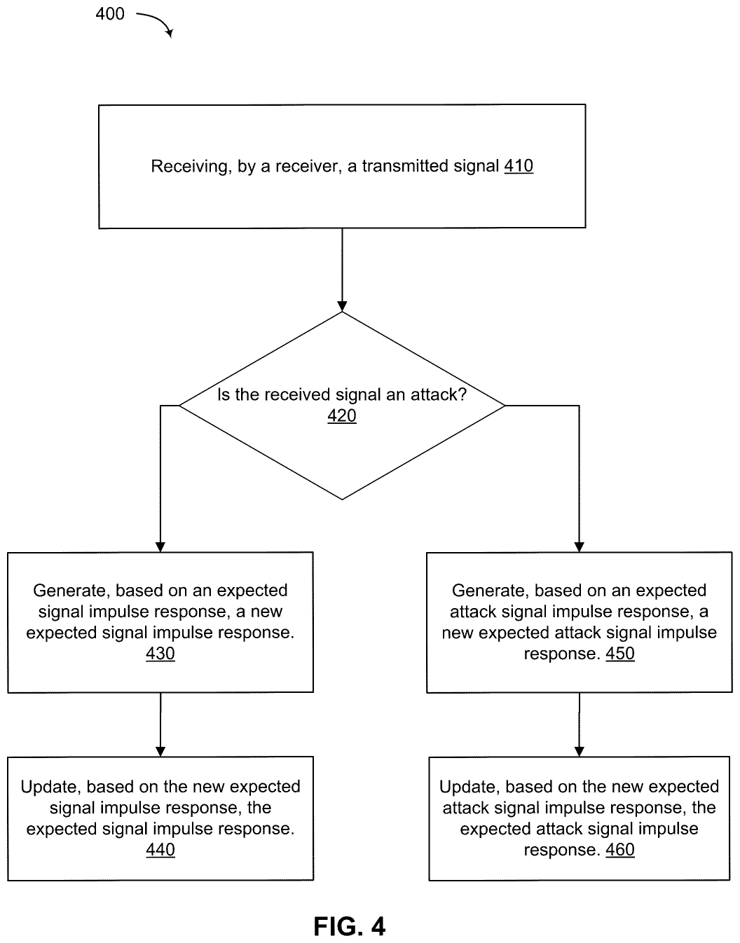

FIG. 4 is a flow diagram of a method 400 of training a wireless device to perform attack detection in RTT using adjustable impulse response, according to various embodiments. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the receiver 104 (e.g., as illustrated in FIG. 1A).

At operation 410, the processing logic receives a transmitted signal. The transmitted signal is transmitted by a transmitter and received by a receiver (e.g., received signal). The transmitted signal may be, for example, a signal not affected by multipath or constructive interference, a signal affected by multipath with destructive interference (e.g., multipath attack), or a signal emulating a specific attack. The receiver may be in training mode, accordingly the received signal is a training signal. The training signal may be transmitted with an indication on whether the training signal does or does not contain an attack pattern.

At operation 430, responsive to an indication that the training signal does or does not contain an attack pattern, the processing logic generates, based on an expected signal impulse response, a new expected signal impulse response. As previously described, the processing logic approximates, using the expected symbols and the expected signal impulse response, an expected signal. The processing logic inputs into a fitting algorithm (e.g., least square method) the training signal and the expected signal to calculate a set of coefficients (e.g., a new expected signal impulse response). The set of coefficients is used to represent the new expected signal impulse response.

At operation 440, the processing logic updates, based on the new expected signal impulse response, the expected signal impulse response. As previously described, a first weight is applied to the expected signal impulse response (e.g., weighted expected signal impulse response) and a second weight is applied to the new expected signal impulse response (e.g., weighted new expected signal impulse response). The weighted expected signal impulse response is added to the weighted new expected signal impulse response to obtain an updated expected signal impulse response. The updated expected signal impulse response may be used to replace the expected signal impulse response.

At operation 450, responsive to an indication that the training signal looks like an attack, the processing logic generates, based on an expected attack signal impulse response, a new expected attack signal impulse response. As previously described, the processing logic approximates, using the expected symbols and the expected attack signal impulse response, an expected signal. The processing logic inputs into a fitting algorithm (e.g., least square method) the training signal and the expected signal to calculate a set of coefficients (e.g., a new expected attack signal impulse response). The set of coefficients is used to represent the new expected attack signal impulse response.

At operation 460, the processing logic updates, based on the new expected attack signal impulse response, the expected attack signal impulse response. As previously described, a first weight is applied to the expected attack signal impulse response (e.g., weighted expected attack signal impulse response) and a second weight is applied to the new expected attack signal impulse response (e.g., weighted new expected attack signal impulse response). The weighted expected attack signal impulse response is added to the weighted new expected attack signal impulse response to obtain an updated expected attack signal impulse response. The updated expected attack signal impulse response may be used to replace the expected attack signal impulse response.

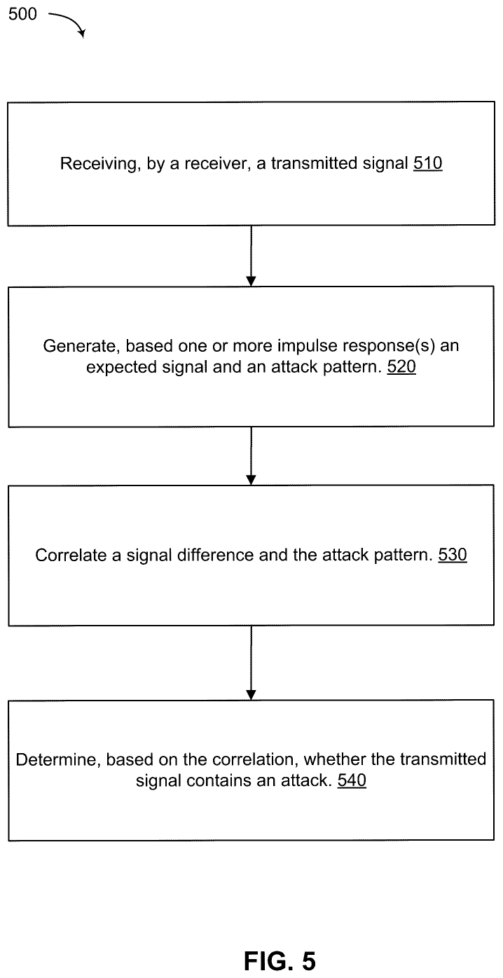

FIG. 5 is a flow diagram of a method 500 of performing attack detection in RTT using adjustable impulse response, according to various embodiments. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the receiver 104 (e.g., as illustrated in FIG. 1A).

At operation 510, the processing logic receives a transmitted signal. The transmitted signal is transmitted by a transmitter and received by a receiver (e.g., received signal). At operation 520, the processing logic generates, based one or more impulse response(s) an expected signal and an attack plan. As previously described, the processing logic approximates, using the expected symbols and an impulse response for an expected signal (e.g., expected signal impulse response) to generate an expected signal. Additionally, the processing logic approximates, using the expected symbols and an impulse response for an attack pattern (e.g., attack pattern impulse response) to generate an attack pattern.

At operation 530, the processing logic correlates a signal difference and the attack pattern. As previously described, the signal difference refers to subtracting the expected signal from the received signal. The processing logic computes a correlation by performing a dot product of the signal difference and the attack pattern. At operation 540, the processing logic determines, based on the correlation, whether the transmitted signal contains an attack pattern (or is an attack). As previously described, the processing logic compares the correlation with one or more thresholds to determine whether the received signal is a specific attack.

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like), so that when executed by the processor(s) or the equivalents thereof, the instructions cause the device(s) to perform the described operations for USB-C/PD mode-transition architecture described herein. The non-transitory computer-readable storage medium may include, but is not limited to, electromagnetic storage medium, read-only memory (ROM), random-access memory (RAM), erasable programmable memory (e.g., EPROM and EEPROM), flash memory, or another now-known or later-developed non-transitory type of medium that is suitable for storing information.

Although the operations of the circuit(s) and block(s) herein are shown and described in a particular order, in some embodiments, the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A wireless device comprising:
a receiver; and
logic at least one of coupled to or integrated within the receiver, the logic is to perform operations comprising:
receiving, from a transmitter, a signal;
generating, based on an expected signal impulse response, a first expected signal;
generating, based on an attack pattern impulse response, an attack pattern; and
determining, based on the signal, the first expected signal, and the attack pattern, whether an attack is present in the signal.

2. The wireless device of claim 1, wherein the first expected signal is generated using the expected signal impulse response and expected symbols.

3. The wireless device of claim 1, wherein the logic is to perform operations further comprising:
during training of the receiver, receiving, from a transmitter, a training signal;
receiving an indication that the training signal does not contain an attack pattern associated with an attack;
generating, based on an expected signal impulse response, a second expected signal;
computing, based on the second expected signal and the training signal, a new expected signal impulse response; and
modifying, based on the new expected signal impulse response, the expected signal impulse response.

4. The wireless device of claim 3, wherein the new expected signal impulse response is computed using a fitting algorithm.

5. The wireless device of claim 1, wherein the logic is to perform operations further comprising:
during training of the receiver, receiving, from a transmitter, a training signal;
receiving an indication that the training signal contains an attack pattern associated with an attack;
generating, based on an expected attack signal impulse response, a third expected signal;
computing, based on the third expected signal and the training signal, a new expected attack signal impulse response; and
modifying, based on the new expected attack signal impulse response, the expected attack signal impulse response.

6. The wireless device of claim 5, wherein the logic is to perform operations further comprising:
generating, based on the expected attack signal impulse response and the expected signal impulse response, a new attack pattern impulse response; and
modifying, based on new attack pattern impulse response, the attack pattern impulse response.

7. The wireless device of claim 1, wherein the logic is to perform operations further comprising:
prior to generating the first expected signal, generating, using one or more configuration parameters of the receiver, a new expected signal impulse response used to modify the expected signal impulse response; and
prior to generating the attack pattern, generating, using one or more parameters of the receiver, a new attack pattern impulse response used to modify the attack pattern impulse response.

8. A method comprising:
receiving, from a transmitter, a signal by a receiver;
generating, based on an expected signal impulse response, a first expected signal;
generating, based on an attack pattern impulse response, an attack pattern; and
determining, based on the signal, the first expected signal, the attack pattern, whether an attack is present in the signal.

9. The method of claim 8, wherein the first expected signal is generated using the expected signal impulse response and expected symbols.

10. The method of claim 8, further comprising:
during training of the receiver, receiving, from a transmitter, a training signal;
receiving an indication that the training signal does not contain an attack pattern associated with an attack;
generating, based on an expected signal impulse response, a second expected signal;
computing, based on the second expected signal and the training signal, a new expected signal impulse response; and
modifying, based on the new expected signal impulse response, the expected signal impulse response.

11. The method of claim 10, wherein the new expected signal impulse response is computed using a fitting algorithm.

12. The method of claim 8, further comprising:
during training of the receiver, receiving, from a transmitter, a training signal;
receiving an indication that the training signal contains an attack pattern associated with an attack;
generating, based on an expected attack signal impulse response, a third expected signal;
computing, based on the third expected signal and the training signal, a new expected attack signal impulse response; and
modifying, based on the new expected attack signal impulse response, the expected attack signal impulse response.

13. The method of claim 12, further comprising:
generating, based on the expected attack signal impulse response and the expected signal impulse response, a new attack pattern impulse response; and
modifying, based on new attack pattern impulse response, the attack pattern impulse response.

14. The method of claim 8, further comprising:
prior to generating the first expected signal, generating, using one or more configuration parameters of the receiver, a new expected signal impulse response used to modify the expected signal impulse response; and
prior to generating the attack pattern, generating, using one or more parameters of the receiver, a new attack pattern impulse response used to modify the attack pattern impulse response.

15. A system comprising:
an antenna;
a transmission device that is to transmit a packet;
a receiving device; and
logic at least one of coupled to or integrated with the receiver, the logic is to perform operations comprising:
receiving, from a transmitter, a signal;
generating, based on an expected signal impulse response, a first expected signal;
generating, based on an attack pattern impulse response, an attack pattern; and
determining, based on the signal, the first expected signal, and the attack pattern, whether an attack is present in the signal.

16. The system of claim 15, wherein the first expected signal is generated using the expected signal impulse response and expected symbols.

17. The system of claim 15, wherein the logic is to perform operations further comprising:
during training of the receiver, receiving, from a transmitter, a training signal;
receiving an indication that the training signal does not contain an attack pattern associated with an attack;
generating, based on an expected signal impulse response, a second expected signal;
computing, based on the second expected signal and the training signal, a new expected signal impulse response; and
modifying, based on the new expected signal impulse response, the expected signal impulse response.

18. The system of claim 15, wherein the logic is to perform operations further comprising: during training of the receiver, receiving, from a transmitter, a training signal;
receiving an indication that the training signal contains an attack pattern associated with an attack;
generating, based on an expected attack signal impulse response, a third expected signal;
computing, based on the third expected signal and the training signal, a new expected attack signal impulse response; and
modifying, based on the new expected attack signal impulse response, the expected attack signal impulse response.

19. The system of claim 18, wherein the logic is to perform operations further comprising:
generating, based on the expected attack signal impulse response and the expected signal impulse response, a new attack pattern impulse response; and
modifying, based on new attack pattern impulse response, the attack pattern impulse response.

20. The system of claim 15, wherein the logic is to perform operations further comprising:
prior to generating the first expected signal, generating, using one or more configuration parameters of the receiver, a new expected signal impulse response used to modify the expected signal impulse response; and
prior to generating the attack pattern, generating, using one or more parameters of the receiver, a new attack pattern impulse response used to modify the attack pattern impulse response.
